(19) United States
(12) Patent Application Publication
(10) Pub. No.: US 2026/0099026 A1
(43) Pub. Date: Apr. 9, 2026

(54) OPTICAL FIBER CABLE AND METHOD OF INSPECTING OPTICAL FIBER CABLE

(71) Applicant: SUMITOMO ELECTRIC INDUSTRIES, LTD., Osaka (JP)

(72) Inventors: Toyoaki KIMURA, Osaka (JP); Takao HIRAMA, Osaka (JP); Yuji NORISUGI, Osaka (JP); Fumikazu YOSHIZAWA, Osaka (JP); Shogo MIYOSHI, Osaka (JP); Ken TAKAHASHI, Osaka (JP); Fumiaki SATO, Osaka (JP); Yohei SUZUKI, Osaka (JP)

(21) Appl. No.: 19/111,486

(22) PCT Filed: May 12, 2023
(86) PCT No.: PCT/JP2023/017981

§ 371 Date: Mar. 13, 2025

(51) Int. Cl. G02B 6/44; G01M 11/00

(52) U.S. Cl. CPC G02B 6/449; G01M 11/33

(57) ABSTRACT

An optical fiber cable includes: a core including a plurality of optical fibers; and a wrapping longitudinally folded around the core, the core is subjected to SZ twisting in which a twisting direction is periodically reversed, the wrapping is folded at a twisting angle due to untwisting of the SZ twisting of the core, and a twisting angle of the core and the twisting angle of the wrapping have a predetermined correlation.

### TECHNICAL FIELD

The present disclosure relates to an optical fiber cable and a method of inspecting an optical fiber cable.

### BACKGROUND ART

In the related art, an optical fiber cable is known which includes a plurality of units in each of which a plurality of optical fibers are concentrated, and in which SZ twisting is applied to the plurality of units. For example, Patent Literature 1 discloses an optical fiber cable which includes a plurality of optical fiber units each including a plurality of optical fibers, a wrapping with which the plurality of optical fiber units are wrapped, and a sheath that covers the wrapping, in which a plurality of outer units located in an outermost layer among the plurality of optical fiber units are twisted in an SZ shape around a cable center axis.

### CITATION LIST

### Patent Literature

Patent Literature 1: JP2022-100376B

### SUMMARY OF INVENTION

An optical fiber cable according to an aspect of the present disclosure includes:
a core including a plurality of optical fibers; and
a wrapping longitudinally folded around the core,
the core is subjected to SZ twisting in which a twisting direction is periodically reversed,
the wrapping is folded at a twisting angle due to untwisting of the SZ twisting of the core, and
a twisting angle of the core and the twisting angle of the wrapping have a predetermined correlation.

A method of inspecting an optical fiber cable according to an aspect of the present disclosure is a method of inspecting an optical fiber cable which includes a core including a plurality of optical fibers, and a wrapping folded around the core, and in which the core is subjected to SZ twisting in which a twisting direction is periodically reversed,
the wrapping being folded at a twisting angle due to untwisting of the SZ twisting of the core,
a twisting angle of the core and the twisting angle of the wrapping having a predetermined correlation,
the inspection method including:
measuring the twisting angle of the wrapping; and
inspecting whether the SZ twisting of the core is normally performed based on the twisting angle of the wrapping and the twisting angle of the core.

### BRIEF DESCRIPTION OF DRAWINGS

FIG. 1 is a view showing an example of an optical fiber cable according to an embodiment of the present disclosure.

FIG. 2 is a view showing a configuration of a part of an optical fiber ribbon in a unit shown in FIG. 1.

FIG. 3 is a diagram showing an example of a manufacturing apparatus for manufacturing the optical fiber cable shown in FIG. 1.

FIG. 4 is a graph showing an example of a change in a twisting angle H(θ) of a core shown in FIG. 1.

FIG. 5 is a graph showing an example of a change in a twisting angle G(θ) of a wrapping tape shown in FIG. 1.

FIG. 6 is a graph showing a twisting angle F(θ) of an optical fiber obtained by calculating a difference between the twisting angle H(θ) of the core shown in FIG. 4 and the twisting angle G(θ) of the wrapping tape shown in FIG. 5.

FIG. 7 is a diagram showing a configuration of an inspection device shown in FIG. 3.

FIG. 8 is a flowchart showing an example of a method of manufacturing the optical fiber cable according to the embodiment of the present disclosure.

FIG. 9 is a table illustrating transmission loss and PMD in the optical fiber cable according to the embodiment of the present disclosure.

FIG. 10 is a graph showing an example of a change in the twisting angle H(θ) of the core shown in FIG. 1.

FIG. 11 is a graph showing an example of a change in the twisting angle G(θ) of the wrapping tape after the rough winding string shown in FIG. 1 is wound.

FIG. 12 is a graph showing the twisting angle F(θ) of the optical fiber obtained by calculating a difference between the twisting angle H(θ) of the core shown in FIG. 9 and the twisting angle G(θ) of the wrapping tape shown in FIG. 10.

FIG. 13 is a diagram showing a difference in the twisting angle F(θ) of the optical fiber between when the core shown in FIG. 1 is subjected to SZ twisting and when the core is subjected to both the SZ twisting and helical twisting.

### DESCRIPTION OF EMBODIMENTS

### Technical Problem

As in the optical fiber cable described in Patent Literature 1, in an optical fiber cable in which a core including a plurality of optical fibers is subjected to SZ twisting, untwisting or the like may occur. However, the wrapping that wraps the core is often non-transparent, and it is not easy to confirm whether the SZ twisting of the core inside the wrapping is normally performed.

An object of the present disclosure is to provide an optical fiber cable and a method of inspecting the optical fiber cable in which for the optical fiber cable in which SZ twisting is applied to a core including a plurality of optical fibers, whether the SZ twisting of the core is normally performed can be inspected.

### Advantageous Effects of Present Disclosure

According to the present disclosure, for an optical fiber cable in which SZ twisting is applied to a core including a plurality of optical fibers, whether the SZ twisting of the core is normally performed can be inspected.

### DESCRIPTION OF EMBODIMENTS OF PRESENT DISCLOSURE

First, embodiments of the present disclosure will be listed and described.

(1) An optical fiber cable according to an aspect of the present disclosure includes:
a core including a plurality of optical fibers; and
a wrapping longitudinally folded around the core,
the core is subjected to SZ twisting in which a twisting direction is periodically reversed,
the wrapping is folded at a twisting angle due to untwisting of the SZ twisting of the core, and
a twisting angle of the core and the twisting angle of the wrapping have a predetermined correlation.

With such a configuration, even for the optical fiber cable after the wrapping is folded, by confirming the twisting angle of the wrapping, whether the SZ twisting of the core is normally performed can be inspected based on the predetermined correlation without disassembling the optical fiber cable. Further, by applying the SZ twisting to the core, transmission loss and polarization mode dispersion (PMD) of the optical fiber can be reduced.

(2) In the optical fiber cable according to (1),
a difference between the twisting angle of the core and the twisting angle of the wrapping may be 0.4 times or more the twisting angle of the core.

Thus, by using the relation between the twisting angle of the core and the twisting angle of the wrapping, whether the SZ twisting of the core is normally performed can be easily determined.

(3) In the optical fiber cable according to (1) or (2),
the core and the wrapping may be further subjected to helical twisting in which a twisting direction is constant.

With such a configuration, in a longitudinal direction of the optical fiber cable, portions where the twisting direction changes are randomly arranged in a peripheral direction, so that the transmission loss and the PMD can be further reduced.

(4) The optical fiber cable according to (3) may further include:
a rough winding string spirally wound around the wrapping.

With such a configuration, fraying of the wrapping can be prevented by the rough winding string, and the core and the wrapping can be spirally twisted.

(5) In the optical fiber cable according to (3),
a period of the helical twisting applied to the core and the wrapping may be within a range of 0.5 times to 15 times a period of the SZ twisting of the core.

Here, when the period of the helical twisting is smaller than 0.5 times the period of the SZ twisting of the core, manufacture is difficult because the period of the twisting is too short. Meanwhile, when the period of the helical twisting is larger than 15 times the period of the SZ twisting of the core, it is difficult to obtain an effect of applying the helical twisting because a period of the twisting is too long.

Therefore, as described above, when the period of the helical twisting is within the range of 0.5 times to 15 times the period of the SZ twisting of the core, the manufacture is easy, and the transmission loss and the PMD can be reduced due to the helical twisting.

A method of inspecting an optical fiber cable according to an aspect of the present disclosure is
(6) a method of inspecting an optical fiber cable which includes a core including a plurality of optical fibers, and a wrapping folded around the core, and in which the core is subjected to SZ twisting in which a twisting direction is periodically reversed,
the wrapping being folded at a twisting angle due to untwisting of the SZ twisting of the core,
a twisting angle of the core and the twisting angle of the wrapping having a predetermined correlation,
the inspection method including:
measuring the twisting angle of the wrapping; and
inspecting whether the SZ twisting of the core is normally performed based on the twisting angle of the wrapping and the twisting angle of the core.

With such a method, even for the optical fiber cable after the wrapping is folded, by confirming the twisting angle of the wrapping, whether the SZ twisting of the core is normally performed can be inspected based on the predetermined correlation without disassembling the optical fiber cable. Further, by applying the SZ twisting to the core, the transmission loss and the PMD of the optical fiber can be reduced.

### Details of Embodiments of Present Disclosure

A specific example of an optical fiber cable according to an embodiment of the present disclosure will be described below with reference to the drawings. The present disclosure is not limited to these exemplifications, but is indicated by the scope of claims, and is intended to include all modifications within a scope and meaning equivalent to the scope of claims.

### [Configuration of Optical Fiber Cable]

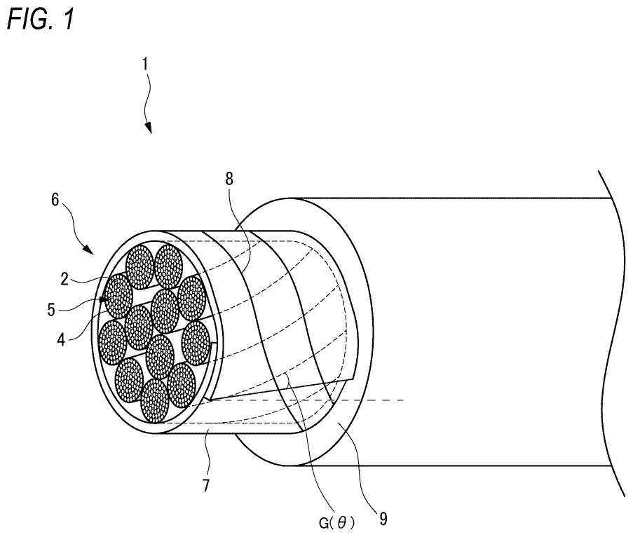

FIG. 1 is a view showing an example of an optical fiber cable 1 according to an embodiment of the present disclosure. Referring to FIG. 1, the optical fiber cable 1 includes a core 6 including a plurality of units 5, a wrapping tape 7 folded around the core 6, a rough winding string 8 wound around the wrapping tape 7, and a cable sheath 9 covering the wrapping tape 7. The core 6 is a cable core portion of the optical fiber cable 1. Each of the units 5 in the core 6 includes a plurality of optical fibers 2, and the plurality of optical fibers 2 are covered with, for example, a hollow tube 4.

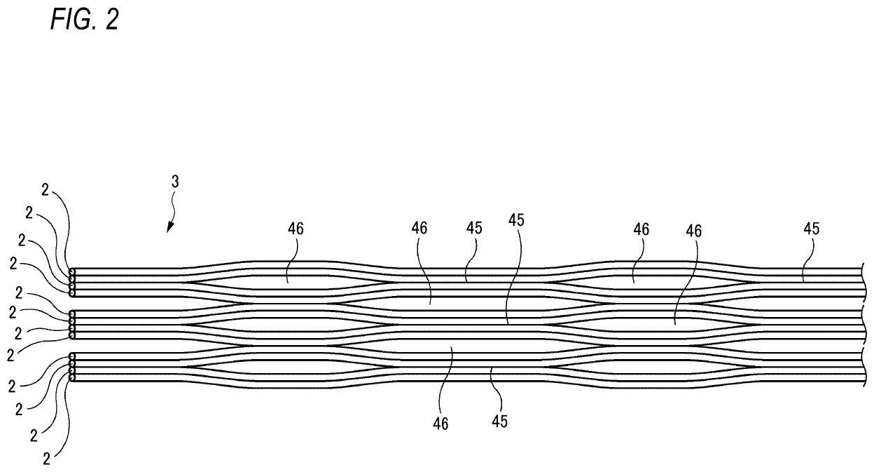

FIG. 2 is a view showing a configuration of a part of an optical fiber ribbon 3 in the unit 5 shown in FIG. 1. In the example shown in FIG. 2, twelve optical fibers 2 are shown, and the twelve optical fibers 2 form a twelve-core optical fiber ribbon 3. The twelve optical fibers 2 are, for example, arranged in parallel in groups with each group including two optical fibers 2, and the two optical fibers 2 in each group are connected over an entire length in a longitudinal direction.

Further, the groups adjacent to each other are intermittently connected to each other. Specifically, between the groups, coupled portions 45 and slit portions 46 are alternately provided along the longitudinal direction. The 12-core optical fiber ribbon 3 is not limited to the configuration shown in FIG. 2, and for example, the slit portion 46 may be provided for each one optical fiber 2 or for each three or more optical fibers 2.

Each unit 5 shown in FIG. 1 includes, for example, six 12-core optical fiber ribbons 3, and these six optical fiber ribbons 3 are twisted together. That is, each unit 5 includes 72 optical fibers 2. Further, the core 6 includes, for example, 12 units 5, and SZ twisting in which a twisting direction is periodically reversed is applied to these units 5.

The wrapping tape 7 is longitudinally folded around the optical fiber cable 1 in the longitudinal direction. The wrapping tape 7 is folded to form overlapping portions by, for example, overlapping width-direction end portions.

The wrapping tape 7 holds the plurality of units 5 subjected to the SZ twisting, and functions as a drop prevention layer that prevents a resin from dropping between the plurality of units 5 when the cable sheath 9 is formed by extrusion molding of the resin, or a heat shield layer when the cable sheath 9 is extruded. As the wrapping tape 7, for example, a nonwoven fabric made of fibers such as polyester, polyethylene, and polypropylene is used.

The rough winding string 8 is spirally wound around the wrapping tape 7. The cable sheath 9 is formed by extruding a resin around the wrapping tape 7 with the rough winding string 8 wound around. The resin for forming the cable sheath 9 is, for example, polyvinyl chloride (PVC) or polyethylene.

### [Manufacturing Apparatus]

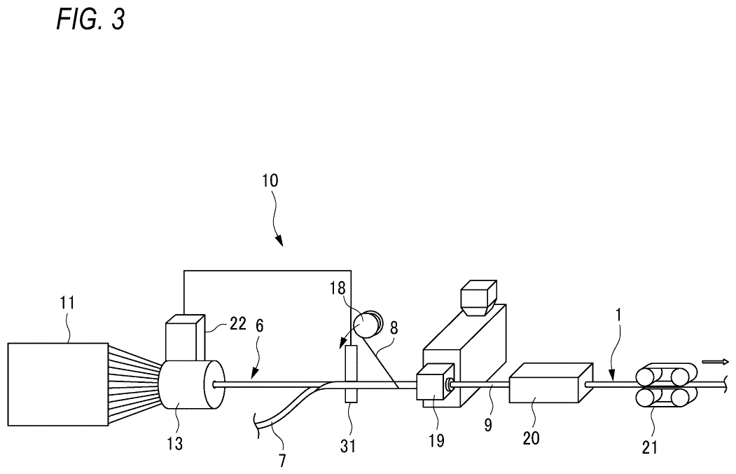

FIG. 3 is a diagram showing an example of a manufacturing apparatus 10 for manufacturing the optical fiber cable 1 shown in FIG. 1. Referring to FIG. 3, the manufacturing apparatus 10 of the optical fiber cable 1 includes, as an example, a supply device 11, a concentrator 13, a rough winding string feeding bobbin 18, an extrusion molding device 19, a cooling device 20, a cable capstan 21, a drive device 22, and an inspection device 31.

The supply device 11 supplies the plurality of units 5 to the concentrator 13. The drive device 22 is coupled to a motor that is not shown and rotates the motor to periodically repeat clockwise rotation and counterclockwise rotation at a predetermined rotation speed. The concentrator 13 is coupled to the motor, and as the motor rotates, the SZ twisting is applied to the plurality of units 5 passing through the concentrator 13, that is, the core 6. For example, the concentrator 13 repeats a movement of clockwise rotating 720° (hereinafter referred to as “+720°”) and then counterclockwise rotating 720° (hereinafter referred to as “−720°”).

The wrapping tape 7 is folded around the core 6 on which the SZ twisting is applied, and then the rough winding string 8 fed out from the rough winding string feeding bobbin 18 is wound around the wrapping tape 7. Accordingly, fraying of the wrapping tape 7 is prevented.

The inspection device 31 measures a movement of the wrapping tape 7 and determines whether the SZ twisting is normally performed on the core 6 based on the measurement result. Details of the inspection device 31 will be described later.

The extrusion molding device 19 extrudes the cable sheath 9 around the wrapping tape 7 with the rough winding string 8 wound around. The extruded cable sheath 9 is cooled and cured by the cooling device 20. The cooled optical fiber cable 1 is taken up by the cable capstan 21 and then wound up by a winding bobbin (not shown).

[Relation between Twisting Angle H(θ) of Core 6 and Twisting Angle G(θ) of Wrapping Tape 7]

Here, an angle of the SZ twisting of the core 6 with respect to the longitudinal direction of the optical fiber cable 1 (hereinafter referred to as “twisting angle of the core 6”) is a preset twisting angle with respect to the drive device 22. When the set twisting angle of the core 6 is defined as a “set value R(θ)”, the core 6 is twisted as set, and thus a twisting angle H(θ) of the core 6 is equal to the set value R(θ) (H(θ)=R(θ)).

However, even when the motor rotates as instructed, the core 6 is untwisted. Then, the wrapping tape 7 is folded at a twisting angle under an influence of the untwisting of the core 6. Hereinafter, an angle of the SZ twisting of the wrapping tape 7 with respect to the longitudinal direction of the optical fiber cable 1 is referred to as a “twisting angle G(θ) of the wrapping tape 7”.

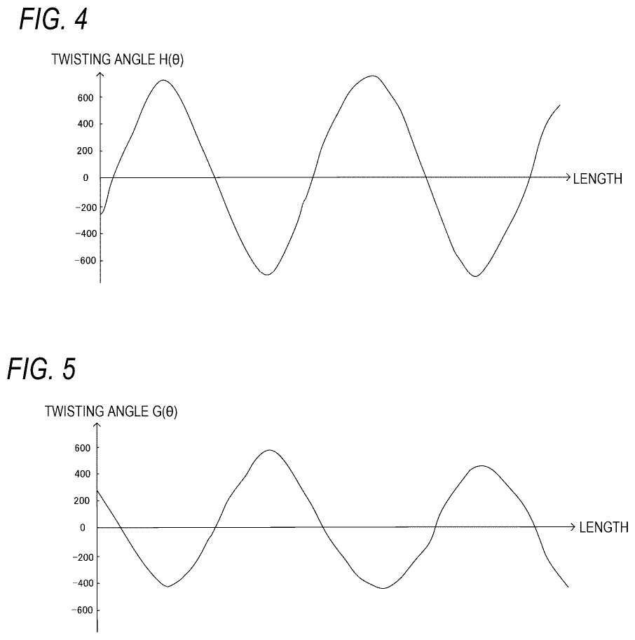

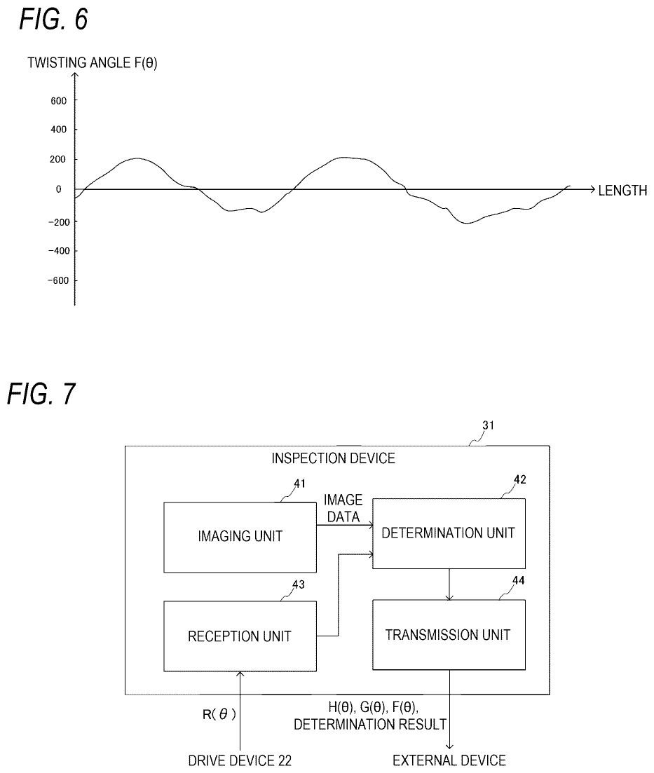

FIG. 4 is a graph showing an example of a change in the twisting angle H(θ) of the core 6 shown in FIG. 1. FIG. 5 is a graph showing an example of a change in the twisting angle G(θ) of the wrapping tape 7 shown in FIG. 1. Further, FIG. 6 is a graph showing a twisting angle F(θ) of the optical fiber 2 obtained by calculating a difference between the twisting angle H(θ) of the core 6 shown in FIG. 4 and the twisting angle G(θ) of the wrapping tape 7 shown in FIG. 5. The twisting angle F(θ) of the optical fiber 2 is obtained by calculating the difference between the twisting angle H(θ) of the core 6 shown in FIG. 4 and the twisting angle G(θ) of the wrapping tape 7 shown in FIG. 5. More specifically, when the twisting angle H(θ) of the core 6 is a positive value, a difference obtained by subtracting an absolute value of the twisting angle G(θ) of the wrapping tape 7 from the twisting angle H(θ) of the core 6 is calculated as the twisting angle F(θ) of the optical fiber 2. Further, when the twisting angle H(θ) of the core 6 is a negative value, a value obtained by multiplying a difference, which is obtained by subtracting the absolute value of the twisting angle G(θ) of the wrapping tape 7 from an absolute value of the twisting angle H(θ) of the core 6, by “−1” is calculated as the twisting angle F(θ) of the optical fiber 2. Since the wrapping tape 7 moves in a direction opposite to a twisting direction of the core 6 due to the influence of untwisting, the twisting angle H(θ) of the core 6 and the twisting angle G(θ) of the wrapping tape 7 are inverted in phase.

In the graphs shown in FIGS. 4 to 6, a horizontal axis indicates a length of the optical fiber cable 1, and a vertical axis indicates an angle. In the example shown in FIGS. 4 to 6, a pitch of the SZ twisting of the core 6 is 4000 mm, and the concentrator 13 periodically changes a rotation angle between +720° and −720°.

The angle F(θ) shown in FIG. 6 corresponds to a twisting angle at which the optical fiber unit 5 (the optical fiber 2) shown in FIG. 1 is actually twisted. Since magnitude of the twisting angle F(θ) of the optical fiber 2 is affected by a degree of the untwisting of the core 6, whether the SZ twisting of the core 6 is normally performed can be inspected by confirming a value of the twisting angle F(θ) of the optical fiber 2.

### [Inspection Device]

FIG. 7 is a diagram showing a configuration of the inspection device 31 shown in FIG. 3. Referring to FIG. 7, the inspection device 31 includes an imaging unit 41, a determination unit 42, a reception unit 43, and a transmission unit 44.

The imaging unit 41 images a movement of the wrapping tape 7 perpendicular to the longitudinal direction of the optical fiber cable 1, which is a movement of the wrapping tape 7 before the rough winding string 8 is wound, and outputs image data indicating the captured image to the determination unit 42. The determination unit 42 measures the twisting angle G(θ) of the wrapping tape 7 by performing image analysis or the like on the image data received from the imaging unit 41 (see FIG. 1).

The drive device 22 shown in FIG. 3 transmits data indicating the set value R(θ) to the inspection device 31. When receiving the data indicating the set value R(θ) from the drive device 22, the reception unit 43 in the inspection device 31 outputs the data to the determination unit 42.

When receiving the data from the reception unit 43, the determination unit 42 sets the set value R(θ) indicated by the data as the twisting angle H(θ) of the core 6. Then, the determination unit 42 determines whether the twisting angle H(θ) of the core 6 and the twisting angle G(θ) of the wrapping tape 7 have a predetermined correlation. For example, as shown in Formula (1), the determination unit 42 determines whether the twisting angle F(θ) of the optical fiber 2 obtained from the difference between the twisting angle H(θ) of the core 6 and the twisting angle G(θ) of the wrapping tape 7 is 0.4 times or more the twisting angle H(θ) of the core 6.

$$F ( θ ) = H ( θ ) - G ( θ ) \geq H ( θ ) \times 0.4 \qquad ( 1 )$$

Then, when the relation between the twisting angle H(θ) of the core 6 and the twisting angle G(θ) of the wrapping tape 7 satisfies Formula (1), the determination unit 42 determines that the degree of untwisting of the core 6 is within an allowable range and the SZ twisting of the core 6 is normally performed. On the other hand, when the relation between the twisting angle H(θ) of the core 6 and the twisting angle G(θ) of the wrapping tape 7 does not satisfy Formula (1), the determination unit 42 determines that the degree of untwisting of the core 6 is not within the allowable range, and thus the SZ twisting of the core 6 is abnormal.

Further, the determination unit 42 outputs, for example, data indicating the twisting angle H(θ) of the core 6, data indicating the twisting angle G(θ) of the wrapping tape 7, data indicating the twisting angle F(θ) of the optical fiber 2, and the determination result to the transmission unit 44. When receiving the data and the determination result from the determination unit 42, the transmission unit 44 transmits, for example, the data and the determination result to an external device (not shown) having a display unit such as a monitor.

When the external device receives the data and the determination result from the inspection device 31, for example, based on the received data, the external device displays three graphs as shown in FIGS. 4 to 6 on the same chart on a screen of the display unit, and displays contents of the determination result on the screen. As described above, since the determination result is displayed on the screen, a user can easily confirm whether the SZ twisting of the core 6 is normally performed.

The twisting angle F(θ) of the optical fiber 2 not only can be measured by calculating the difference between the twisting angle H(θ) of the core 6 and the twisting angle G(θ) of the wrapping tape 7, but also can be measured by emitting visible light into the optical fiber 2.

Specifically, the visible light is incident on the manufactured optical fiber cable 1 from an end portion of the optical fiber 2, and a position of the optical fiber 2 on which the visible light is incident is observed on a plurality of cross sections obtained by cleaving the core 6. Thus, the twisting angle F(θ) of the optical fiber 2 can be measured.

### [Flow of Operation]

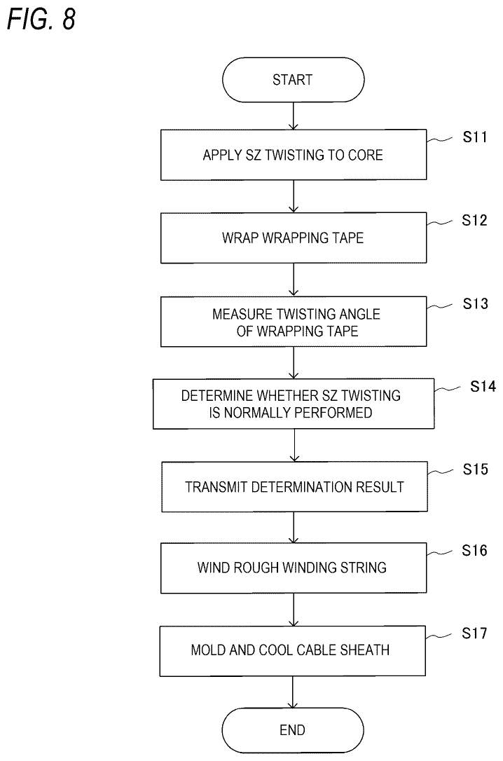

Next, a method of manufacturing the optical fiber cable 1 including a method of inspecting the optical fiber cable 1 will be described with reference to a flowchart. FIG. 8 is a flowchart showing an example of the method of manufacturing the optical fiber cable 1 according to the embodiment of the present disclosure. Here, a flow of operations after a step of applying the SZ twisting to the core 6 will be described.

Referring to FIGS. 3 and 8, first, when the drive device 22 rotates the motor, the motor rotates, and the concentrator 13 connected to the motor rotates to periodically repeat clockwise rotation and counterclockwise rotation. Thus, the SZ twisting is applied to the core 6 passing through the concentrator 13 (step S11).

Next, the wrapping tape 7 is fed out toward the core 6 to which the SZ twisting is applied, and is longitudinally folded along the longitudinal direction of the optical fiber cable 1. At this time, the wrapping tape 7 is SZ-twisted under the influence of the untwisting of the core 6 (step S12).

Next, the inspection device 31 images the wrapping tape 7 and measures the twisting angle G(θ) of the wrapping tape 7 based on the captured image (step S13).

Next, the inspection device 31 sets the set value R(θ) as the twisting angle H(θ) of the core 6 and inspects whether the SZ twisting of the core 6 is normally performed based on the twisting angle H(θ) of the core 6 and the twisting angle G(θ) of the wrapping. Specifically, for example, the inspection device 31 determines whether the twisting angle H(θ) of the core 6 and the twisting angle G(θ) of the wrapping tape 7 satisfy Formula (1) (step S14).

Then, the inspection device 31 transmits the determination result to the external device (step S15). In step S14, when it is determined that the SZ twisting is abnormal, for example, an abnormal position information corresponding to a length direction of the optical fiber cable 1 is stored into a storage medium of the inspection device 31 or a storage medium of the external device.

Next, the rough winding string 8 is wound around the wrapping tape 7 (step S16). Then, the extrusion molding device 19 extrudes the cable sheath 9 around the wrapping tape 7, and the cooling device 20 cools and cures the cable sheath 9 (step S17). The optical fiber cable 1 manufactured in this manner is wound up by a winding-up bobbin or the like. When the optical fiber cable 1 is rewound from the winding-up bobbin to a product shipping bobbin, an abnormal portion of the optical fiber cable 1 may be removed based on the abnormal position information, and only a normal portion of the optical fiber cable 1 may be wound up on the product shipping bobbin.

### [Transmission Loss and PMD]

### (Change in Transmission Loss and PMD Due to Z Twisting of Core 6)

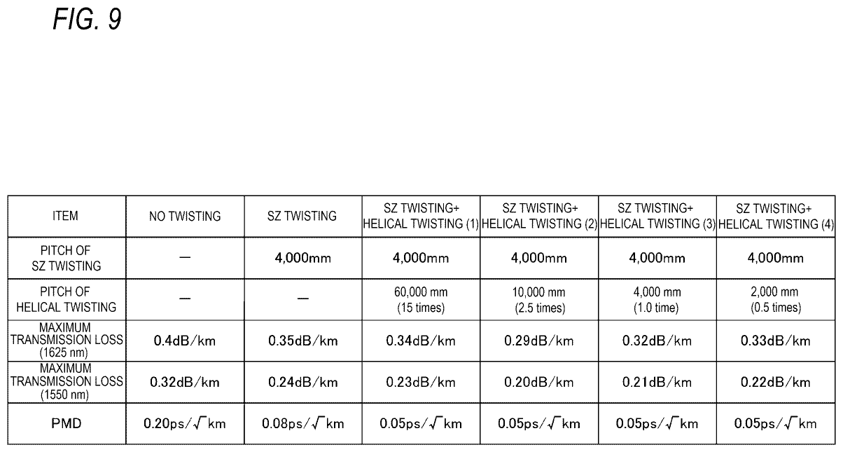

FIG. 9 is a table illustrating transmission loss and PMD in the optical fiber cable 1 according to the embodiment of the present disclosure. Referring to FIG. 9, when no SZ twisting is applied to the core 6 of the optical fiber cable 1 (see “no twisting” in the table shown in FIG. 9), maximum transmission loss of the optical fiber 2 was 0.4 dB/km at a wavelength of 1625 nm and 0.32 dB/km at a wavelength of 1550 nm. The PMD was 0.20 ps/√km.

Meanwhile, when the SZ twisting was applied to the core 6 at a pitch of 4000 mm (see “SZ twisting” in the table shown in FIG. 9), the maximum transmission loss of the optical fiber 2 decreased to 0.35 dB/km at a wavelength of 1625 nm and decreased to 0.24 dB/km at a wavelength of 1550 nm. The PMD was reduced to 0.08 ps/√km.

As described above, in the optical fiber cable 1 of the present disclosure, the transmission loss and the PMD of the optical fiber 2 can be reduced by applying the SZ twisting to the core 6.

As described above, the wrapping tape 7 is SZ-twisted under the influence of untwisting of the core 6. As a result, even when the optical fiber cable 1 is bent, the overlapping portions are oriented in random directions with respect to an inner side and an outer side of the bending, so that the overlapping portions of the wrapping tape 7 can be prevented from opening, and durability of the optical fiber cable 1 can be improved.

### (Change in Transmission Loss and PMD Due to Spiral Winding of Rough Winding String 8)

In the optical fiber cable 1 of the present disclosure, as described above, the rough winding string 8 is spirally wound around the wrapping tape 7. Accordingly, since the core 6 and the wrapping tape 7 are twisted under an influence of the winding of the rough winding string 8, helical twisting in which a twisting direction is constant is performed in addition to the SZ twisting.

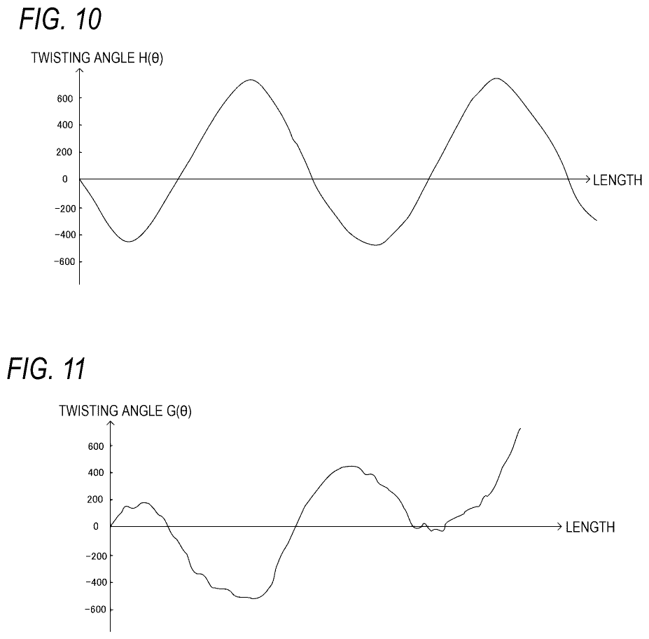

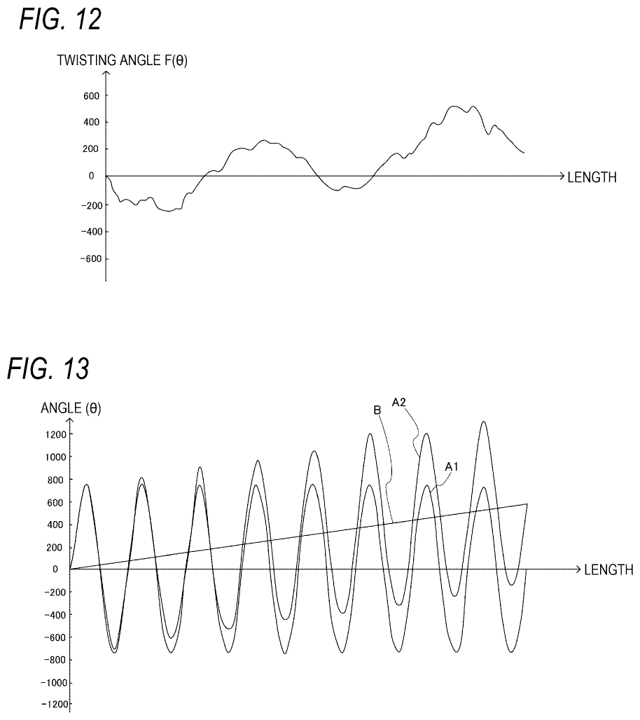

FIG. 10 is a graph showing an example of a change in the twisting angle H(θ) of the core 6 shown in FIG. 1. FIG. 11 is a graph showing an example of a change in the twisting angle G(θ) of the wrapping tape 7 after the rough winding string 8 shown in FIG. 1 is wound. Further, FIG. 12 is a graph showing the twisting angle F(θ) of the optical fiber 2 obtained by calculating a difference between the twisting angle H(θ) of the core 6 shown in FIG. 9 and the twisting angle G(θ) of the wrapping tape 7 shown in FIG. 10.

In the graphs shown in FIGS. 10 to 12, a horizontal axis indicates the length of the optical fiber cable 1, and a vertical axis indicates the angle. In the examples shown in FIGS. 10 to 12, a pitch of the SZ twisting of the core 6 is 8000 mm, and a pitch of the spiral winding of the rough winding string 8, that is, a pitch of the helical twisting is 16000 mm. The concentrator 13 periodically changes the rotation angle between +720° and −720°.

FIG. 13 is a diagram showing a difference in the twisting angle F(θ) of the optical fiber 2 between when the core 6 shown in FIG. 1 is subjected to SZ twisting and when the core 6 is subjected to both the SZ twisting and the helical twisting.

A graph A1 in FIG. 13 schematically shows the twisting angle F(θ) of the optical fiber 2 when the core 6 is subjected to the SZ twisting, that is, the twisting angle F(θ) shown in FIG. 6. A graph B in FIG. 13 schematically shows a twisting angle of the helical twisting applied to the core 6. A graph A2 in FIG. 13 schematically shows the twisting angle F(θ) of the optical fiber 2 when both the SZ twisting and the helical twisting are applied to the core 6, that is, the twisting angle F(θ) shown in FIG. 12.

When comparing the graph A1 and the graph A2, an angle serving as a rotation center of the twisting angle F(θ) of the optical fiber 2 gradually increases along the longitudinal direction of the optical fiber cable 1 when both the SZ twisting and the helical twisting are applied to the core 6. As a result, portions where the twisting direction changes in the longitudinal direction of the optical fiber cable 1 are made random in a peripheral direction, the transmission loss and the PMD can be further reduced.

Referring again to FIG. 9, it is assumed that the SZ twisting is applied to the core 6 at a pitch of 4000 mm, and the helical twisting is applied to the core 6 and the wrapping tape 7 at a pitch of 15 times the pitch of the SZ twisting, that is, a pitch of 60000 mm (see “SZ twisting+helical twisting (1)” in the table shown in FIG. 9). In this case, the maximum transmission loss of the optical fiber 2 was 0.34 dB/km at a wavelength of 1625 nm and 0.23 dB/km at a wavelength of 1550 nm. The PMD was 0.05 ps/√km.

Further, it is assumed that the SZ twisting is applied to the core 6 at a pitch of 4000 mm, and the helical twisting is applied to the core 6 and the wrapping tape 7 at a pitch of 2.5 times the pitch of the SZ twisting, that is, a pitch of 10000 mm (see “SZ twisting+helical twisting (2)” in the table shown in FIG. 9). In this case, the maximum transmission loss of the optical fiber 2 was 0.29 dB/km at a wavelength of 1625 nm and 0.20 dB/km at a wavelength of 1550 nm. The PMD was 0.05 ps/√km.

Further, it is assumed that the SZ twisting is applied to the core 6 at a pitch of 4000 mm, and the helical twisting is applied to the core 6 and the wrapping tape 7 at a pitch of 1.0 time the pitch of the SZ twisting, that is, a pitch of 4000 mm (see “SZ twisting+helical twisting (3)” in the table shown in FIG. 9). In this case, the maximum transmission loss of the optical fiber 2 was 0.32 dB/km at a wavelength of 1625 nm and 0.21 dB/km at a wavelength of 1550 nm. The PMD was 0.05 ps/√km.

Further, it is assumed that the SZ twisting is applied to the core 6 at a pitch of 4000 mm, and the helical twisting is applied to the core 6 and the wrapping tape 7 at a pitch of 0.5 times the pitch of the SZ twisting, that is, a pitch of 2000 mm (see “SZ twisting+helical twisting (4)” in the table shown in FIG. 9). In this case, the maximum transmission loss of the optical fiber 2 was 0.33 dB/km at a wavelength of 1625 nm and 0.22 dB/km at a wavelength of 1550 nm. The PMD was 0.05 ps/√km.

Thus, it can be confirmed that when both the SZ twisting and the helical twisting are applied to the core 6, the transmission loss and the PMD can be further reduced as compared with the case where only the SZ twisting is applied to the core 6 (“SZ twisting” in the table shown in FIG. 9).

When the pitch of the helical twisting exceeds 60000 mm, it is difficult to obtain an effect of applying the helical twisting because a period of the twisting is too long. Meanwhile, when the pitch of the helical twisting is smaller than 2000 mm, manufacture is difficult because a period of the twisting is too short. Therefore, a period of the helical twisting applied to the core 6 and the wrapping tape 7 is preferably within a range of 0.5 times to 15 times a period of the SZ twisting of the core 6.

The optical fiber cable 1 is not limited to the configuration in which the rough winding string 8 is wound. For example, the helical twisting may be applied to the core 6 and the wrapping tape 7 by applying a force to the wrapping tape 7 in an oblique direction with respect to the longitudinal direction of the optical fiber cable 1.

The present disclosure has been described above based on the specific embodiment. However, the present disclosure is not limited to these exemplifications, but is indicated by the scope of claims, and is intended to include all modifications within a scope and meaning equivalent to the scope of claims.

### REFERENCE SIGNS LIST

1 optical fiber cable
2 optical fiber
3 optical fiber ribbon
4 tube
5 unit
6 core
7 wrapping tape
8 rough winding string
9 cable sheath
10 manufacturing apparatus
11 supply device
13 concentrator
18 rough winding string feeding bobbin
19 extrusion molding device
20 cooling device
21 cable capstan
22 drive device
31 inspection device
41 imaging unit
42 determination unit
43 reception unit
44 transmission unit
45 coupled portion
46 slit portion
A1, A2, B graph

1. An optical fiber cable comprising:
a core including a plurality of optical fibers; and
a wrapping longitudinally folded around the core, wherein
the core is subjected to SZ twisting in which a twisting direction is periodically reversed,
the wrapping is folded at a twisting angle due to untwisting of the SZ twisting of the core, and
a twisting angle of the core and the twisting angle of the wrapping have a predetermined correlation.

2. The optical fiber cable according to claim 1, wherein
a difference between the twisting angle of the core and the twisting angle of the wrapping is 0.4 times or more the twisting angle of the core.

3. The optical fiber cable according to claim 1, wherein
the core and the wrapping are further subjected to helical twisting in which a twisting direction is constant.

4. The optical fiber cable according to claim 3, further comprising:
a rough winding string spirally wound around the wrapping.

5. The optical fiber cable according to claim 3, wherein
a period of the helical twisting applied to the core and the wrapping is within a range of 0.5 times to 15 times a period of the SZ twisting of the core.

6. A method of inspecting an optical fiber cable which includes a core including a plurality of optical fibers, and a wrapping folded around the core, and in which the core is subjected to SZ twisting in which a twisting direction is periodically reversed,
the wrapping being folded at a twisting angle due to untwisting of the SZ twisting of the core,
a twisting angle of the core and the twisting angle of the wrapping having a predetermined correlation,
the inspection method comprising:
measuring the twisting angle of the wrapping; and
inspecting whether the SZ twisting of the core is normally performed based on the twisting angle of the wrapping and the twisting angle of the core.
